(19) United States
(12) Patent Application Publication
(10) Pub. No.: US 2011/0317962 A1
(43) Pub. Date: Dec. 29, 2011

(54) CABLE ASSEMBLY HAVING FLOATABLE OPTICAL MODULE

(75) Inventors: RICHARD LEE MALEHORN, II, York, PA (US); TOD M. HARLAN, Mechanicsburg, PA (US)

(73) Assignee: HON HAI PRECISION INDUSTRY CO., LTD., Tu-Cheng (TW)

(21) Appl. No.: 12/825,338

(22) Filed: Jun. 29, 2010

(51) Int. Cl. G02B 6/38

(52) U.S. Cl. 385/75; 385/55

(57) ABSTRACT

A cable assembly (100) includes an insulative housing (2) defining a mounting cavity (221); an optical module (5) accommodated in the mounting cavity and capable of moving therein along a front-to-back direction; at least one fiber (6) coupled to the optical module; two resilient members (9) spaced apart from each other along a transversal direction; and a cap (7) integrated with the two resilient members, the cap mounted to the insulative housing to cover the at least one fiber, and the two resilient members pressing against the optical module.

### CROSS-REFERENCE TO RELATED APPLICATIONS

This application is related to U.S. patent application Ser. No. 12/701,619 filed Feb. 8, 2010 and entitled “CABLE ASSEMBLY HAVING FLOATABLE OPTICAL MODULE”, which has the same assignee as the present invention.

### BACKGROUND OF THE INVENTION

1. Field of the Invention

The present invention relates to a cable assembly, more particularly to a cable assembly capable of transmitting optical signal.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connector and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, optical lenses are unable to be floatable with regard to the housing. They are not accurately aligned with, and optically coupled to counterparts, if there are some errors in manufacturing process.

### BRIEF SUMMARY OF THE INVENTION

Accordingly, an object of the present invention is to provide a cable assembly having a floatable optical module.

In order to achieve the above-mentioned object, a cable assembly in accordance with present invention comprises: an insulative housing defining a mounting cavity; an optical module accommodated in the mounting cavity and capable of moving therein along a front-to-back direction; at least one fiber coupled to the optical module; two resilient members spaced apart from each other along a transversal direction; and a cap integrated with the two resilient members, the cap mounted to the insulative housing to cover the at least one fiber, and the two resilient members pressing against the optical module.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a cable assembly in accordance with the first embodiment of the present invention;

FIG. 2 is an exploded, perspective view of FIG. 1;

FIG. 3 is similar to FIG. 2, but viewed from another aspect;

FIG. 4 is an enlarged view of a cap and two resilient members.

FIG. 5 shows the two resilient members integrated with the cap and pressing against an optical module; and

FIG. 6 is a partially assembled view of the cable assembly;

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

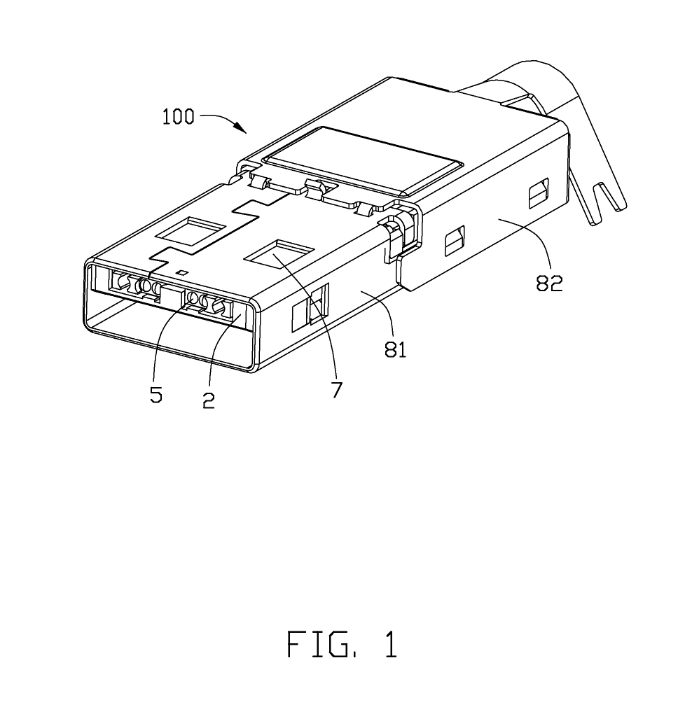

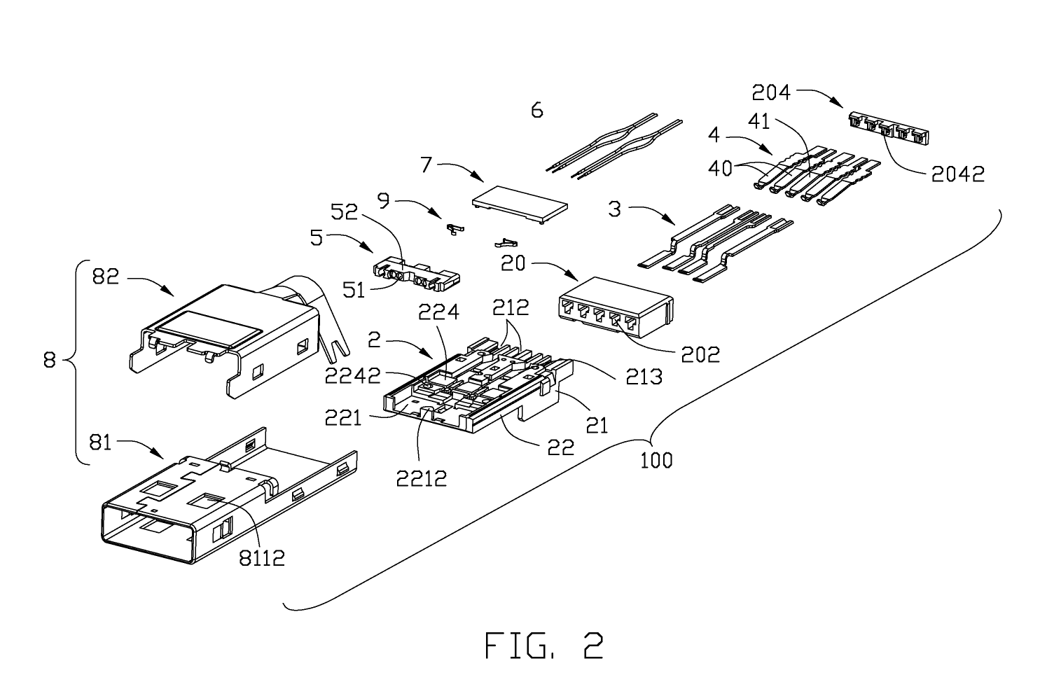

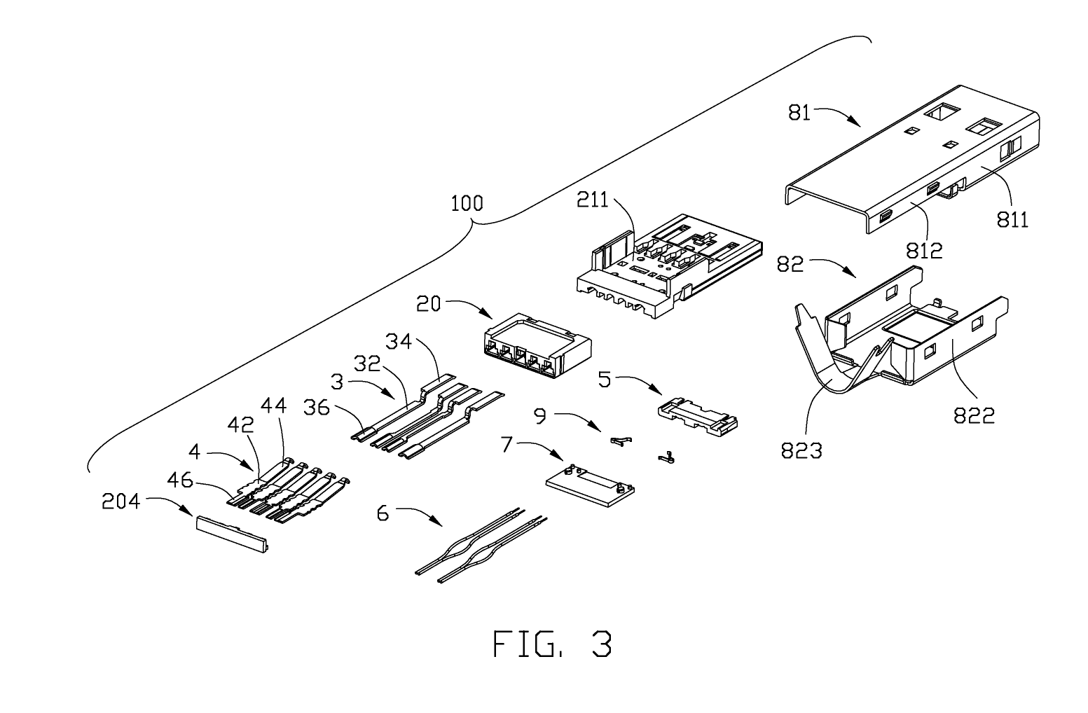

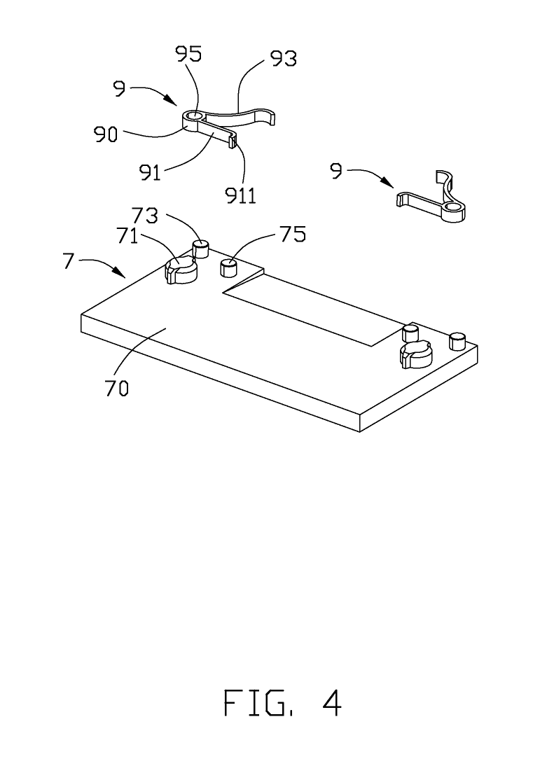

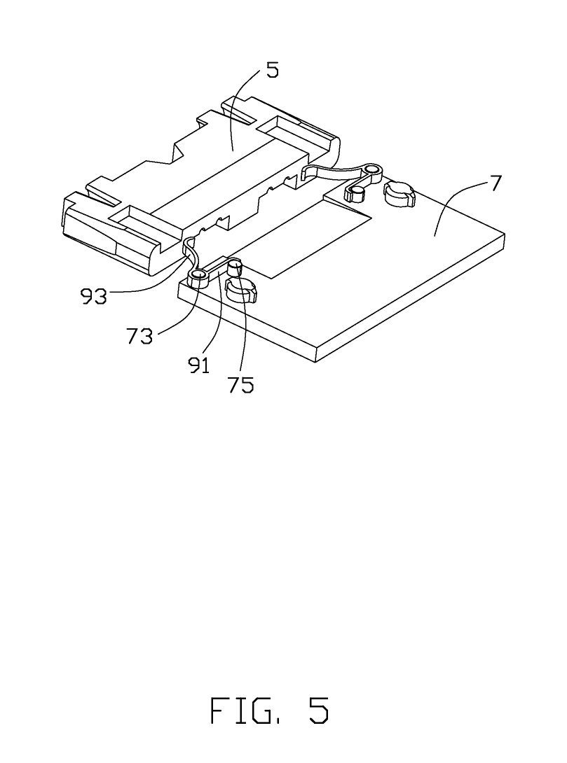

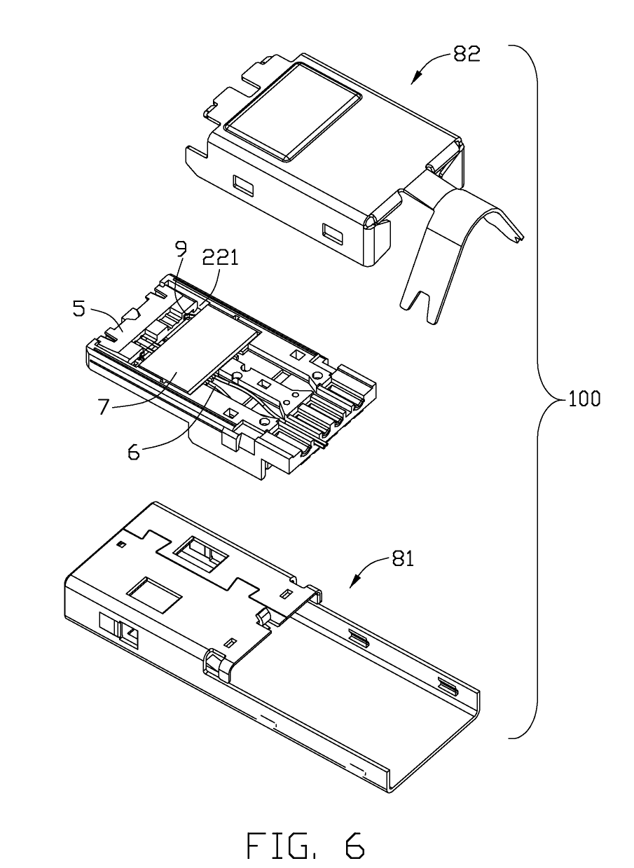

Referring to FIGS. 1-6, a cable assembly 100 in accordance with the present invention is disclosed. The cable assembly 100 comprises an elongated insulative housing 2 extending along a front-to-back direction, a set of first contacts 3, a set of second contacts 4 and an optical modules 5 supported by the insulative housing 2, and a number of fibers 6 coupled to the optical module 5. The cable assembly 1 further comprises a cap member 7, a metal shell 8 and two resilient members 9. The two resilient members 9 can be integrated with the cap 7 and capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in a front portion of the mounting cavity 221. A depression 224 is defined in a rear portion of the tongue portion 22 and communicating with the mounting cavity 221. A number of contact slots 212 are defined in an upper segment of a rear portion of the base portion 21. Two fiber grooves 213 are defined in the base portion 21 and extend along the front-to-back direction, pass the depression 224 and communicate with the mounting cavity 221.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depressed area 226 of the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each second contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the mounting cavity 221.

Four fibers 6 are separated into two groups and enter a rear section of the mounting cavity 221, through the fiber grooves 213 and are coupled to the four lens 51, respectively.

The cap 7 has two crushable ribs 71 are respectively formed at lateral sides of a bottom surface 70 thereof. Two mounting posts 73 are formed on the lateral sides of the bottom surface 70 and located in front of the crushable ribs 71. Furthermore, two anti-rotation posts 75 are formed on the lateral sides of the bottom surface 70, arranged between the two mounting posts 73. The two anti-rotation posts 75 offset the two mounting posts 73 along a horizontal direction.

The two resilient members 9 are spaced apart from each other and mounted to the cap 7. Each of the resilient members 9 has a transversal arm 91 and deflected arm 93 extending forwardly and inwardly from left/right end of the transversal arm 91. Furthermore, a mounting hole 95 is defined in an elbow portion/joining portion 90 between the transversal arm 91 and the deflected arm 93. A bending portion 911 is formed at a free end of the transversal arm 91 and projecting backwardly.

The two resilient members 9 are assembled to the cap 7, with the mounting posts 73 inserted into the mounting hole 95, the transversal arm 91 located in front the anti-rotation post 75 and the bending portion 911 holding the anti-rotation post 75.

The cap 7 is assembled into the depression 224, with the resilient members 9 and the fibers 6 disposed underneath the bottom surface 70 thereof. Two crushable ribs 71 are formed at the bottom surface of the cap 7 and inserted into positioning holes 2242 which are located in the depression 224. In addition, the deflected arms 93 extend into the mounting cavity 221 and press against a back side of the optical module 5. When a pushing force is exerted onto the optical module 5 to press the resilient members 9, and the deflected arms 93 are compressed/pressed to move backwardly. When the pushing force is withdrawn, the deflected arms 93 are restored so as to bias/deflect the optical module 5 along the mounting cavity 221.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 8112 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap member 7 arranged underneath the windows 811, and the base portion 21 is received in the body portion 812. The second shield part 82 is assembled to the first shield part 81, with body portions 822, 812 combined together. The cable assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

What is claimed is:

1. A cable assembly, comprising:
an insulative housing defining a mounting cavity;
an optical module accommodated in the mounting cavity and capable of moving therein along a front-to-back direction;
at least one fiber coupled to the optical module;
two resilient members spaced apart from each other along a transversal direction; and
a cap integrated with the two resilient members, the cap mounted to the insulative housing to cover the at least one fiber, and the two resilient members pressing against the optical module.

2. The cable assembly as claimed in claim 1, wherein each of the two resilient members has a transversal arm and a deflected arm extending forwardly and inwardly from a left or right end of the transversal arm.

3. The cable assembly as claimed in claim 2, wherein the deflected arm presses against back side of the optical module.

4. The cable assembly as claimed in claim 2, wherein there is an elbow portion between the transversal arm and the deflected arm.

5. The cable assembly as claimed in claim 4, wherein there is a mounting hole defined in the elbow portion, and there is a mounting post formed on a bottom surface of the cap and inserted into the mounting hole.

6. The cable assembly as claimed in claim 5, wherein there is a anti-rotation post formed on the bottom surface of the cap and located behind the transversal arm.

7. The cable assembly as claimed in claim 6, wherein the resilient member has a bending portion formed at a free end of the transversal arm and projecting backwardly, and the bending portion holds the anti-rotation post.

8. The cable assembly as claimed in claim 1, wherein the cap member has two crushable ribs respectively formed at lateral sides of a bottom surface thereof, and the insulative housing defines two positioning holes to receive the crushable ribs.

9. The cable assembly as claimed in claim 1, wherein the insulative housing defines depression located behind the mounting cavity, and the cap is assembled into the depression.

10. The cable assembly as claimed in claim 1, further comprising a plurality of contacts mounted to the insulative housing.

11. The cable assembly as claimed in claim 1, wherein the contacts and the optical module are disposed at opposite sides of the insulative housing.

12. The cable assembly as claimed in claim 11, wherein the contacts are divided into a set of first contacts and a set of second contacts.

13. The cable assembly as claimed in claim 12, wherein the set of second contacts are located behind the set of first contacts.

14. The cable assembly as claimed in claim 1, further comprising a metal shell enclosing the insulative housing and the cap.

15. The cable assembly as claimed in claim 14, wherein the metal shell defines a window in a top side thereof, and the cap is disposed underneath the window.

16. A cable connector assembly comprising:
an insulative housing defining a mounting cavity therein;
an optical module accommodated within the mounting cavity and back and forth moveable along a front-to-back direction;
at least one fiber connected to the optical module;
at least one resilient member defining a deflectable arm constantly urging the optical module forwardly; and
a cap member associated with the resilient member in an immovable manner; wherein
said cap member covering the at least one fiber and mounted to the housing.

17. The cable connector assembly as claimed in claim 16, wherein a metallic shell covers the housing and the cover.

18. The cable connector assembly as claimed in claim 16, wherein said resilient member is essentially located between the housing and the cap member in a vertical direction.
